(19) United States
(12) Patent Application Publication
(10) Pub. No.: US 2009/0187016 A1
(43) Pub. Date: Jul. 23, 2009

(54) METHOD FOR PRODUCING CELLULOSE ACETALS

(75) Inventors: Klemens Massone, Bad Dürkheim (DE); Veit Stegmann, Mannheim (DE); Giovanni D'Andola, Heidelberg (DE); Werner Mormann, Siegen (DE); Markus Wezstein, Kirchhundem (DE); Wei Leng, Siegen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/307,336

(22) PCT Filed: Jun. 28, 2007
(86) PCT No.: PCT/EP07/56518

§ 371 Date: Jan. 2, 2009

(30) Foreign Application Priority Data
Jul. 7, 2006 (DE) 10 2006 031 810.2
Nov. 15, 2006 (DE) 10 2006 054 213.4

(51) Int. Cl. C08B 11/20; C08B 11/00

(52) U.S. Cl. 536/89; 536/84

(57) ABSTRACT

The present invention describes a process for preparing acetals of polysaccharides, oligosaccharides or disaccharides by dissolving these in at least one ionic liquid and reacting them with a vinyl ether. The acetalated polysaccharides or oligosaccharides obtained in this way can be crosslinked by treatment with acid. The present invention also provides acetals of polysaccharides, oligosaccharides or disaccharides and also crosslinked polysaccharides or oligosaccharides.

The present invention describes a process for preparing cellulose acetals by reacting cellulose with a vinyl ether in an ionic liquid, and also novel cellulose acetals.

Cellulose is the most important renewable raw material and represents an important starting material for, for example, the textile, paper and nonwovens industries. It also serves as raw material for derivatives and modifications of cellulose, including cellulose ethers such as methylcellulose and carboxymethylcellulose, cellulose esters based on organic acids, e.g. cellulose acetate, cellulose butyrate, and cellulose esters based on inorganic acids, e.g. cellulose nitrate, and others. These derivatives and modifications have many uses, for example in the textile, food, building and surface coatings industry. Cellulose acetate is of particular interest here. It is still desirable to provide further derivatives of cellulose in order to satisfy the requirements of the above industries.

It is known from J. Polymer Science, 51 173 (1961) (T. Fujimura et al.) that cellulose fibers can be treated with glyoxal or glutaraldehyde to form hemiacetals and acetals. In this method, the cellulose fibers are introduced into a bath comprising the dialdehyde. This process is thus a heterogeneous reaction which is greatly affected by the quality of the cellulose fibers used and increased hemiacetal and acetal formation occurs at the surface of the cellulose compared to the core of the fiber, if any hemiacetalization/acetalization takes place there at all.

It is, however, desirable to provide “homogeneous” acetalized cellulose which is not crosslinked and is soluble in customary organic solvents such as ethers, esters, ketones, alcohols or hydrocarbons.

This object is achieved by dissolving cellulose in an ionic liquid and reacting it with a vinyl ether. Furthermore, novel cellulose acetals have been found.

For the purposes of the present invention, ionic liquids are preferably

(A) salts of the general formula (I)

[A]ₙ⁺[Y]ⁿ⁻ (I),
where n is 1, 2, 3 or 4, [A]⁺ is a quaternary ammonium cation, an oxonium cation, a sulfonium cation or a phosphonium cation and [Y]ⁿ⁻ is a monovalent, divalent, trivalent or tetravalent anion;
   (B) mixed salts of the general formulae (II)

[A¹]⁺[A²]⁺[Y]ⁿ⁻ (IIa), where n=2;

[A¹]⁺[A²]⁺[A³]⁺[Y]ⁿ⁻ (IIb), where n=3; or

[A¹]⁺[A²]⁺[A³]⁺[A⁴]⁺[Y]ⁿ⁻ (IIc), where n=4,
where [A¹]⁺, [A²]⁺, [A³]⁺ and [A⁴]⁺ are selected independently from among the groups mentioned for [A]⁺ and [Y]ⁿ⁻ is as defined under (A).

The ionic liquids preferably have a melting point of less than 180° C. The melting point is particularly preferably in the range from −50° C. to 150° C., in particular in the range from −20° C. to 120° C. and extraordinarily preferably below 100° C.

The ionic liquids used according to the invention are organic compounds, i.e. at least one cation or anion of the ionic liquid comprises an organic radical.

Compounds suitable for the formation of the cation [A]⁺ of ionic liquids are known, for example, from DE 102 02 838 A1. Thus, such compounds can comprise oxygen, phosphorus, sulfur or in particular nitrogen atoms, for example at least one nitrogen atom, preferably from 1 to 10 nitrogen atoms, particularly preferably from 1 to 5 nitrogen atoms, very particularly preferably from 1 to 3 nitrogen atoms and in particular 1 or 2 nitrogen atoms. If appropriate, further heteroatoms such as oxygen, sulfur or phosphorus atoms can also be comprised. The nitrogen atom is a suitable carrier of the positive charge in the cation of the ionic liquid, from which a proton or an alkyl radical can then go over in equilibrium to the anion to produce an electrically neutral molecule.

If the nitrogen atom is the carrier of the positive charge in the cation of the ionic liquid, a cation can firstly be produced by quaternization of the nitrogen atom of, for instance, an amine or nitrogen heterocycle in the synthesis of the ionic liquids. Quaternization can be effected by alkylation of the nitrogen atom. Depending on the alkylation reagent used, salts having different anions are obtained. In cases in which it is not possible to form the desired anion in the quaternization itself, this can be brought about in a further step of the synthesis. Starting from, for example, an ammonium halide, the halide can be reacted with a Lewis acid, forming a complex anion from the halide and Lewis acid. As an alternative, replacement of a halide ion by the desired anion is possible. This can be achieved by addition of a metal salt with precipitation of the metal halide formed, by means of an ion exchanger or by displacement of the halide ion by a strong acid (with liberation of the hydrogen halide). Suitable methods are described, for example, in Angew. Chem. 2000, 112, pp. 3926-3945, and the references cited therein.

Suitable alkyl radicals by means of which the nitrogen atom in the amines or nitrogen heterocycles can, for example, be quaternized are C₁-C₁₈alkyl, preferably C₁-C₁₀-alkyl, particularly preferably C₁-C₆-alkyl and very particularly preferably methyl. The alkyl group can be unsubstituted or have one or more identical or different substituents.

Preference is given to compounds which comprise at least one five- or six-membered heterocycle, in particular a five-membered heterocycle, which has at least one nitrogen atom and also, if appropriate, an oxygen or sulfur atom. Particular preference is likewise given to compounds which comprise at least one five- or six-membered heterocycle which has one, two or three nitrogen atoms and a sulfur or oxygen atom, very particularly preferably compounds having two nitrogen atoms. Further preference is given to aromatic heterocycles.

Particularly preferred compounds have a molecular weight below 1000 g/mol, very particularly preferably below 500 g/mol and in particular below 350 g/mol.

Furthermore, preference is given to cations selected from among the compounds of the formulae (IIIa) to (IIIw),

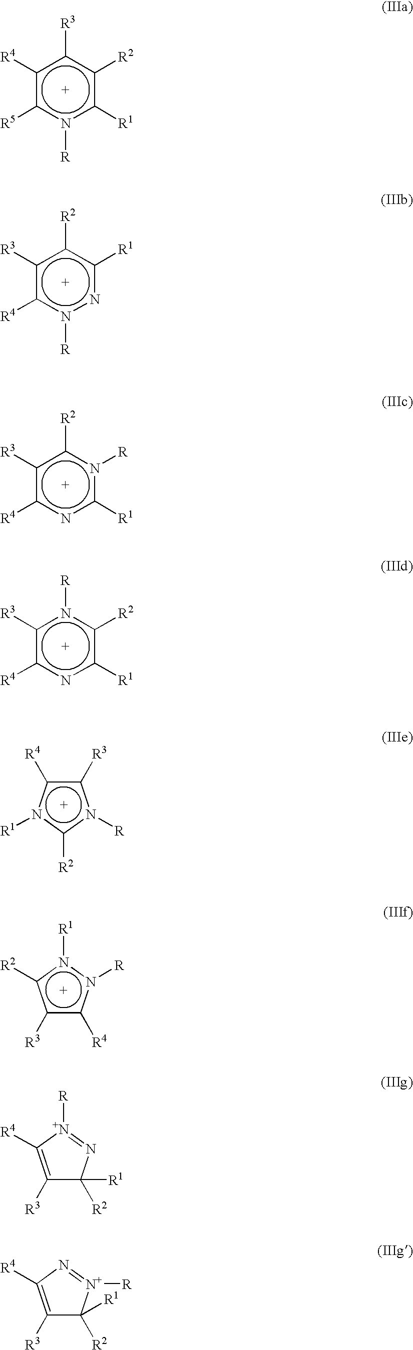

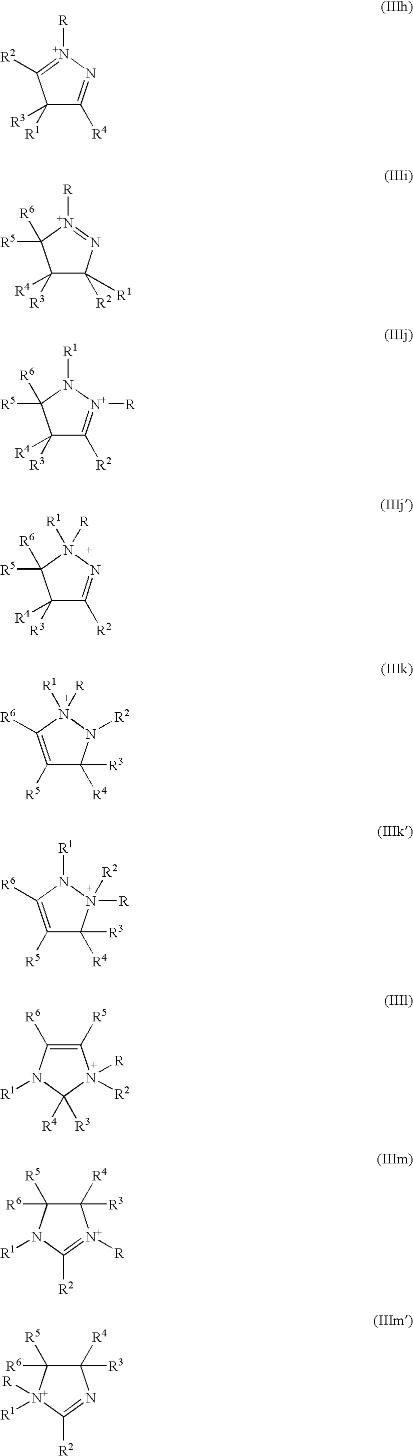

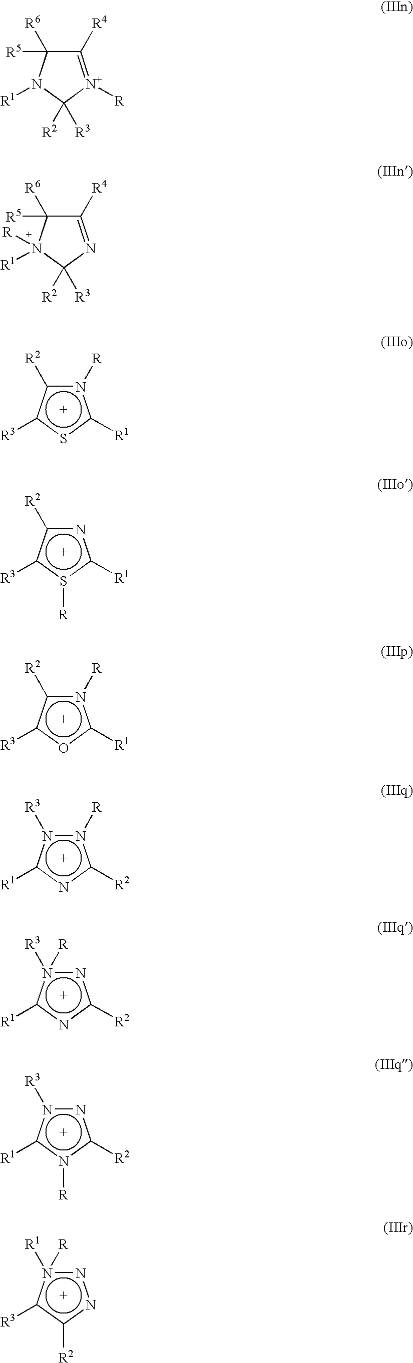

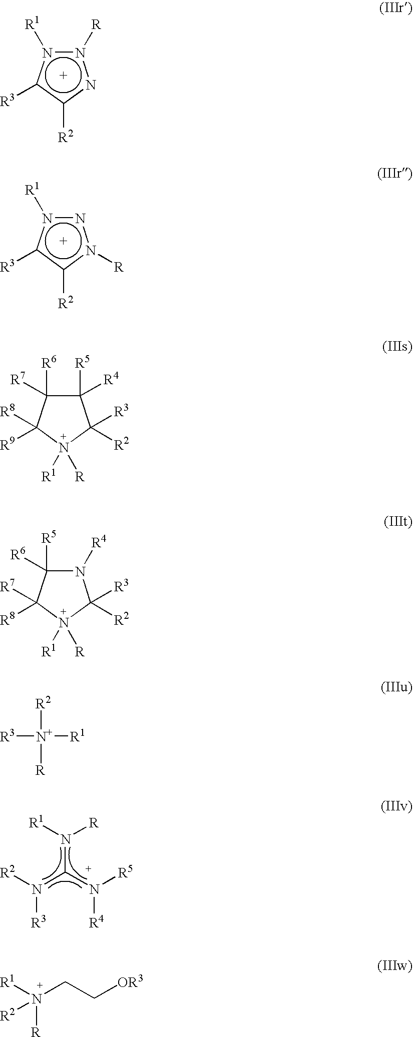

and oligomers comprising these structures.

Further suitable cations are compounds of the general formulae (IIIx) and (IIIy)

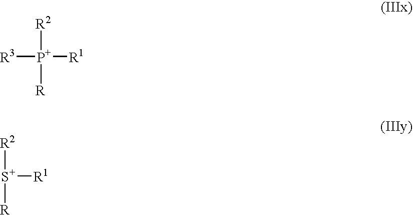

and oligomers comprising these structures.

In the abovementioned formulae (IIIa) to (IIIy),
the radical R is hydrogen or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups; and
the radicals R¹ to R⁹ are each, independently of one another, hydrogen, a sulfo group or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or suitable functional groups, where the radicals R¹ to R⁹ which are bound to a carbon atom (and not to a heteroatom) in the formulae (III) mentioned above are additionally able to be halogen or a functional group; or
two adjacent radicals from the group consisting of R¹ to R⁹ may together also form a divalent, carbon-comprising organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or functional groups.

In the definitions of the radicals R and R¹ to R⁹, possible heteroatoms are in principle all heteroatoms which are able to formally replace a —CH₂— group, a —CH═ group, a —C≡ group or a ═C═ group. If the carbon-comprising radical comprises heteroatoms, then oxygen, nitrogen, sulfur, phosphorus and silicon are preferred. Preferred groups are, in particular, —O—, —S—, —SO—, —SO₂—, —NR′—, —N═, —PR′—, —PR′₃ and —SiR′₂—, where the radicals R′ are the remaining part of the carbon-comprising radical. In the cases in which the radicals R¹ to R⁹ are bound to a carbon atom (and not a heteroatom) in the abovementioned formulae (III), they can also be bound directly via the heteroatom.

Suitable functional groups are in principle all functional groups which can be bound to a carbon atom or a heteroatom and do not react with vinyl ethers. Suitable examples are ═O (in particular as carbonyl group), —NR₂′, ═NR′, and —CN (cyano). Functional groups and heteroatoms can also be directly adjacent, so that combinations of a plurality of adjacent atoms, for instance —O— (ether), —S-(thioether), —COO— (ester) or —CONR′-(tertiary amide), are also comprised, for example di-(C₁-C₄-alkyl)amino, C₁-C₄-alkyloxycarbonyl or C₁-C₄-alkyloxy. The radicals R′ are the remaining part of the carbon-comprising radical.

As halogens, mention may be made of fluorine, chlorine, bromine and iodine.

The radical R is preferably
unbranched or branched C₁-C₁₈-alkyl which may be unsubstituted or substituted by one or more halogen, phenyl, cyano and/or C₁-C₆-alkoxycarbonyl and has a total of from 1 to 20 carbon atoms, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, benzyl, 3-phenylpropyl, 2-cyanoethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl; and undecylfluoroisopentyl,
glycols, butylene glycols and oligomers thereof having from 1 to 100 units, with all the above groups bearing a C₁-C₈-alkyl radical as end group, for example R^{A}O—(CHR^{B}—CH₂—O)ₘ—CHR^{B}—CH₂— or R^{A}O—(CH₂CH₂CH₂CH₂O)ₘ—CH₂CH₂CH₂CH₂— where R^{A} and R^{B} are each preferably methyl or ethyl and m is preferably 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradecyl;
vinyl;
1-propen-1-yl, 1-propen-2-yl and 1-propen-3-yl; and
N,N-di-C₁-C₆-alkylamino such as N,N-dimethylamino and N,N-diethylamino.

The radical R is particularly preferably unbranched and unsubstituted C₁-C₁₈-alkyl, such as methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, 1-propen-3-yl, in particular methyl, ethyl, 1-butyl and 1-octyl, or CH₃O—(CH₂CH₂O)ₘ—CH₂CH₂— and CH₃CH₂O—(CH₂CH₂O)ₘ—CH₂CH₂— where m is 0 to 3.

Preference is given to the radicals R¹ to R⁹ each being, independently of one another,
hydrogen;
halogen;
a suitable functional group;
C₁-C₁₈-alkyl which may optionally be substituted by suitable functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;
C₂-C₁₈-alkenyl which may optionally be substituted by suitable functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;
C₆-C₁₂-aryl which may optionally be substituted by suitable functional groups, aryl, alkyl, aryloxy, alkyloxy, halogen, heteroatoms and/or heterocycles;
C₅-C₁₂-cycloalkyl which may optionally be substituted by suitable functional groups, aryl, alkyl, aryloxy, alkyloxy, halogen, heteroatoms and/or heterocycles;
C₅-C₁₂-cycloalkenyl which may optionally be substituted by suitable functional groups, aryl, alkyl, aryloxy, alkyloxy, halogen, heteroatoms and/or heterocycles; or
a five- or six-membered, oxygen-, nitrogen- and/or sulfur-comprising heterocycle which may optionally be substituted by suitable functional groups, aryl, alkyl, aryloxy, alkyloxy, halogen, heteroatoms and/or heterocycles; or two adjacent radicals together form
an unsaturated, saturated or aromatic ring which may optionally be substituted by suitable functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups.

C₁-C₁₈-alkyl which may optionally be substituted by suitable functional groups, aryl, alkyl, aryloxy, alkyloxy, halogen, heteroatoms and/or heterocycles is preferably methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethyl-pentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl, cyclopentyl-methyl, 2-cyclopentylethyl, 3-cyclopentylpropyl, cyclohexylmethyl, 2-cyclohexylethyl, 3-cyclohexylpropyl, benzyl (phenylmethyl), diphenylmethyl (benzhydryl), triphenyl-methyl, 1-phenylethyl, 2-phenylethyl, 3-phenylpropyl, α,α-dimethylbenzyl, p-tolyl-methyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxy-carbonylethyl, 2-butoxycarbonylpropyl, 1,2-di-(methoxycarbonyl)ethyl, methoxy, ethoxy, formyl, 1,3-dioxolan-2-yl, 1,3-dioxan-2-yl, 2-methyl-1,3-dioxolan-2-yl, 4-methyl-1,3-dioxolan-2-yl, 2-dimethylaminoethyl, 2-dimethylaminopropyl, 3-dimethylaminopropyl, 4-dimethylaminobutyl, 6-dimethylaminohexyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, 6-ethoxyhexyl, acetyl, CₘF_{2(m-a)+(1-b)}H_{2a+b} where m is from 1 to 30, 0≦a≦m and b=0 or 1 (for example CF₃, C₂F₅, CH₂CH₂—C₍ₘ₋₂₎F₂₍ₘ₋₂₎₊₁, C₆F₁₃, C₈F₁₇, C₁₀F₂₁, C₁₂F₂₅), chloromethyl, 2-chloroethyl, trichloromethyl, 1,1-dimethyl-2-chloroethyl, methoxymethyl, 2-butoxyethyl, diethoxymethyl, diethoxyethyl, 2-isopropoxyethyl, 2-butoxypropyl, 2-octyloxyethyl, 2-methoxyisopropyl, 2-(methoxycarbonyl)ethyl, 2-(ethoxycarbonyl)ethyl, 2-(n-butoxycarbonyl)ethyl, butylthiomethyl, 2-dodecylthioethyl, 2-phenylthioethyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

C₂-C₁₈-alkenyl which may optionally be substituted by suitable functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups is preferably vinyl, 2-propenyl, 3-butenyl, cis-2-butenyl, trans-2-butenyl or CₘF_{2(m-a)-(1-b)H}_{2a-b} where m≦30, 0≦a≦m and b=0 or 1.

C₆-C₁₂-aryl which may optionally be substituted by suitable functional groups, aryl, alkyl, aryloxy, alkyloxy, halogen, heteroatoms and/or heterocycles is preferably phenyl, tolyl, xylyl, β-naphthyl, α-naphthyl, 4-diphenylyl, chlorophenyl, dichlorophenyl, trichloro-phenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl or tert-butylthiophenyl or C₆F₍₅₋ₐ₎Hₐ where 0≦a≦5.

C₅-C₁₂-cycloalkyl which may optionally be substituted by suitable functional groups, aryl, alkyl, aryloxy, alkyloxy, halogen, heteroatoms and/or heterocycles is preferably cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, CₘF_{2(m-a)-(1-b)}H_{2a-b} where m≦30, 0≦a≦m and b=0 or 1, or a saturated or unsaturated bicyclic system such as norbornyl or norbornenyl.

C₅- to C₁₂-cycloalkenyl which may optionally be substituted by suitable functional groups, aryl, alkyl, aryloxy, alkyloxy, halogen, heteroatoms and/or heterocycles is preferably 3-cyclopentenyl, 2-cyclohexenyl, 3-cyclohexenyl, 2,5-cyclohexadienyl or CₙF_{2(m-a)-3(1-b)}H_{2a-3b} where m≦30, 0≦a≦m and b=0 or 1.

A five- or six-membered, oxygen-, nitrogen- and/or sulfur-comprising heterocycle which may optionally be substituted by suitable functional groups, aryl, alkyl, aryloxy, alkyloxy, halogen, heteroatoms and/or heterocycles is preferably furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl or difluoropyridyl.

If two adjacent radicals together form an unsaturated, saturated or aromatic ring which may optionally be substituted by suitable functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups, they preferably form 1,3-propylene, 1,4-butylene, 1,5-pentylene, 2-oxa-1,3-propylene, 1-oxa-1,3-propylene, 2-oxa-1,3-propylene, 1-oxa-1,3-propenylene, 3-oxa-1,5-pentylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

If the abovementioned radicals comprise oxygen and/or sulfur atoms and/or substituted or unsubstituted imino groups, the number of oxygen and/or sulfur atoms and/or imino groups is not subject to any restrictions. In general, there will be no more than 5 in the radical, preferably no more than 4 and very particularly preferably no more than 3.

If the abovementioned radicals comprise heteroatoms, there is generally at least one carbon atom, preferably at least two carbon atoms, between any two heteroatoms.

Particular preference is given to the radicals R¹ to R⁹ each being, independently of one another,
hydrogen;
unbranched or branched C₁-C₁₈-alkyl which may be unsubstituted or substituted by one or more H, halogen, phenyl, cyano, and/or C₁-C₆-alkoxycarbonyl groups and has a total of from 1 to 20 carbon atoms, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, benzyl, 3-phenylpropyl, 2-cyanoethyl, 2-(methoxycarbonyl)ethyl, 2-(ethoxycarbonyl)ethyl, 2-(n-butoxy-carbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl and undecylfluoroisopentyl;
glycols, butylenes glycols and oligomers thereof having from 1 to 100 units, with all the above groups bearing a C₁-C₈-alkyl radical as end group, for example R^{A}O—(CHR^{B}—CH₂—O)ₘ—CHR^{B}—CH₂— or R^{A}O—(CH₂CH₂CH₂CH₂O)ₘ—CH₂CH₂CH₂CH₂— where R^{A} and R^{B} are each preferably methyl or ethyl and n is preferably 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradecyl;
vinyl;
1-propen-1-yl, 1-propen-2-yl and 1-propen-3-yl; and
N,N-di-C₁-C₆-alkylamino, such as N,N-dimethylamino and N,N-diethylamino;
   where, when IIIw is III, then R³ is not hydrogen.

Very particular preference is given to the radicals R¹ to R⁹ each being, independently of one another, hydrogen or C₁-C₁₈-alkyl such as methyl, ethyl, 1-butyl, 1-pentyl, 1-hexyl, 1-heptyl, 1-octyl, phenyl, 2-cyanoethyl, 2-(methoxycarbonyl)ethyl, 2-(ethoxycarbonyl)ethyl, 2-(n-butoxycarbonyl)ethyl, N,N-dimethylamino, N,N-diethylamino, chlorine or CH₃O—(CH₂CH₂O)ₘ—CH₂CH₂— and CH₃CH₂O—(CH₂CH₂O)ₘ—CH₂CH₂— where m is from 0 to 3.

Very particularly preferred pyridinium ions (IIIa) are those in which
one of the radicals R¹ to R⁵ is methyl, ethyl or chlorine and the remaining radicals R¹ to R⁵ are each hydrogen;
R³ is dimethylamino and the remaining radicals R¹, R², R⁴ and R⁵ are each hydrogen;
all radicals R¹ to R⁵ are hydrogen;
R¹ and R² or R² and R³ are 1,4-buta-1,3-dienylene and the remaining radicals R¹, R², R⁴ and R⁵ are each hydrogen;
   and in particular those in which
R¹ to R⁵ are each hydrogen; or
one of the radicals R¹ to R⁵ is methyl or ethyl and the remaining radicals R¹ to R⁵ are each hydrogen.

As very particularly preferred pyridinium ions (IIIa), mention may be made of 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium and 1-(1-octyl)-2-methyl-3-ethyl-pyridinium, 1-(1-dodecyl)-2-methyl-3-ethylpyridinium, 1-(1-tetradecyl)-2-methyl-3-ethylpyridinium and 1-(1-hexadecyl)-2-methyl-3-ethyl-pyridinium.

Very particularly preferred pyridazinium ions (IIIb) are those in which
R¹ bis R⁴ are each hydrogen; or
one of the radicals R¹ to R⁴ is methyl or ethyl and the remaining radicals R¹ to R⁴ are each hydrogen.

Very particularly preferred pyridinium ions (IIIc) are those in which
R¹ is hydrogen, methyl or ethyl and R² to R⁴ are each, independently of one another, hydrogen or methyl; or
R¹ is hydrogen, methyl or ethyl, R² and R⁴ are each methyl and R³ is hydrogen.

Very particularly preferred pyrazinium ions (IIId) are those in which
R¹ is hydrogen, methyl or ethyl and R² to R⁴ are each, independently of one another, hydrogen or methyl;
R¹ is hydrogen, methyl or ethyl, R² and R⁴ are each methyl and R³ is hydrogen;
R¹ to R⁴ are each methyl; or
R¹ to R⁴ are each methyl or hydrogen.

Very particularly preferred imidazolium ions (Ille) are those in which
R¹ is hydrogen, methyl, ethyl, 1-propyl, 1-butyl, 1-pentyl, 1-hexyl, 1-octyl, 1-propen-3-yl or 2-cyanoethyl and R² to R⁴ are each, independently of one another, hydrogen, methyl or ethyl.

As very particularly preferred imidazolium ions (IIIe), mention may be made of 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

Very particularly preferred pyrazolium ions (IIIf), (IIIg) and (IIIg′) are those in which
R¹ is hydrogen, methyl or ethyl and R² to R⁴ are each, independently of one another, hydrogen or methyl.

Very particularly preferred pyrazolium ions (IIIh) are those in which
R¹ to R⁴ are each, independently of one another, hydrogen or methyl.

Very particularly preferred 1-pyrazolinium ions (IIIi) are those in which
R¹ to R⁶ are each, independently of one another, hydrogen or methyl.

Very particularly preferred 2-pyrazolinium ions (IIIj) and (IIIj′) are those in which
R¹ is hydrogen, methyl, ethyl or phenyl and R² to R⁶ are each, independently of one another, hydrogen or methyl.

Very particularly preferred 3-pyrazolinium ions (IIIk) and (IIIk′) are those in which
R¹ and R² are each, independently of one another, hydrogen, methyl, ethyl or phenyl and R³ to R⁶ are each, independently of one another, hydrogen or methyl.

Very particularly preferred imidazolinium ions (IIIl) are those in which
R¹ and R² are each, independently of one another, hydrogen, methyl, ethyl, 1-butyl or phenyl, R³ and R⁴ are each, independently of one another, hydrogen, methyl or ethyl and R⁵ and R⁶ are each, independently of one another, hydrogen or methyl.

Very particularly preferred imidazolinium ions (IIIm) and (IIIm′) are those in which
R¹ and R² are each, independently of one another, hydrogen, methyl or ethyl and R³ to R⁶ are each, independently of one another, hydrogen or methyl.

Very particularly preferred imidazolinium ions (IIIn) and (IIIn′) are those in which
R¹ to R³ are each, independently of one another, hydrogen, methyl or ethyl and R⁴ to R⁶ are each, independently of one another, hydrogen or methyl.

Very particularly preferred thiazolium ions (IIIo) and (IIIo′) and oxazolium ions (IIIp) are those in which
R¹ is hydrogen, methyl, ethyl or phenyl and R² and R³ are each, independently of one another, hydrogen or methyl.

Very particularly preferred 1,2,4-triazolium ions (IIIq), (IIIq′) and (IIIq″) are those in which
R¹ and R² are each, independently of one another, hydrogen, methyl, ethyl or phenyl and R³ is hydrogen, methyl or phenyl.

Very particularly preferred 1,2,3-triazolium ions (IIIr), (IIIr′) and (IIIr″) are those in which
R¹ is hydrogen, methyl or ethyl and R² and R³ are each, independently of one another, hydrogen or methyl or R² and R³ are together 1,4-buta-1,3-dienylene.

Very particularly preferred pyrrolidinium ions (IIIs) are those in which
R¹ is hydrogen, methyl, ethyl or phenyl and R² to R⁹ are each, independently of one another, hydrogen or methyl.

Very particularly preferred imidazolidinium ions (IIIt) are those in which
R¹ and R⁴ are each, independently of one another, hydrogen, methyl, ethyl or phenyl and R² and R³ and also R⁵ to R⁸ are each, independently of one another, hydrogen or methyl.

Very particularly preferred ammonium ions (IIIu) are those in which
R¹ to R³ are each, independently of one another, C₁-C₁₈-alkyl; or
R¹ and R² are together 1,5-pentylene or 3-oxa-1,5-pentylene and R³ is C₁-C₁₈-alkyl or 2-cyanoethyl.

As very particularly preferred ammonium ions (IIIu), mention may be made of methyl-tri-(1-butyl)ammonium, N,N-dimethylpiperidinium and N,N-dimethylmorpholinium.

Examples of tertiary amines from which the quaternary ammonium ions of the general formula (IIIu) are derived by quaternization with the radicals R mentioned are diethyl-n-butylamine, diethyl-tert-butylamine, diethyl-n-pentylamine, diethyl-hexylamine, diethyloctylamine, diethyl(2-ethylhexyl)amine, di-n-propylbutylamine, di-n-propyl-n-pentylamine, di-n-propylhexylamine, di-n-propyloctylamine, di-n-propyl(2-ethylhexyl)amine, diisopropylethylamine, diisopropyl-n-propylamine, diisopropyl-butylamine, diisopropylpentylamine, diisopropylhexylamine, diisopropyloctylamine, diisopropyl(2-ethylhexyl)amine, di-n-butylethylamine, di-n-butyl-n-propylamine, di-n-butyl-n-pentylamine, di-n-butylhexylamine, di-n-butyloctylamine, di-n-butyl(2-ethyl-hexyl)amine, N-n-butylpyrrolidine, N-sec-butylpyrrolidine, N-tert-butylpyrrolidine, N-n-pentylpyrrolidine, N,N-dimethylcyclohexylamine, N,N-diethylcyclohexylamine, N,N-di-n-butylcyclohexylamine, N-n-propylpiperidine, N-isopropylpiperidine, N-n-butylpiperidine, N-sec-butylpiperidine, N-tert-butylpiperidine, N-n-pentylpiperidine, N-n-butylmorpholine, N-sec-butylmorpholine, N-tert-butylmorpholine, N-n-pentylmorpholine, N-benzyl-N-ethylaniline, N-benzyl-N-n-propylaniline, N-benzyl-N-isopropylaniline, N-benzyl-N-n-butylaniline, N,N-dimethyl-p-toluidine, N,N-diethyl-p-toluidine, N,N-di-n-butyl-p-toluidine, diethylbenzylamine, di-n-propylbenzylamine, di-n-butylbenzylamine, diethylphenylamine, di-n-Propylphenylamine and di-n-butylphenylamine.

Preferred quaternary ammonium ions of the general formula (IIIu) are those which can be derived from the following tertiary amines by quaternization by means of the radicals R mentioned, e.g. diisopropylethylamine, diethyl-tert-butylamine, diisopropylbutylamine, di-n-butyl-n-pentylamine, N,N-di-n-butylcyclohexylamine and tertiary amines derived from pentyl isomers.

Particularly preferred tertiary amines are di-n-butyl-n-pentylamine and tertiary amines derived from pentyl isomers. A further preferred tertiary amine which has three identical radicals is triallylamine.

Very particularly preferred guanidinium ions (IIIv)′ are those in which
R¹ to R⁵ are each methyl.

As a very particularly preferred guanidinium ion (IIIv), mention may be made of N,N,N′,N′, N″, N″-hexamethylguanidinium.

Very particularly preferred cholinium ions (IIIw) are those in which
R¹ and R² are each, independently of one another, methyl, ethyl, 1-butyl or 1-octyl and R³ is methyl, ethyl or acetyl;
R¹ is methyl, ethyl, 1-butyl or 1-octyl, R² is a —CH₂—CH₂—OR⁴ group and R³ and R⁴ are each, independently of one another, methyl, ethyl or acetyl; or
R¹ is a —CH₂—CH₂—OR⁴ group, R² is a —CH₂—CH₂—OR⁵ group and R³ to R⁵ are each, independently of one another, methyl, ethyl or acetyl.

Particularly preferred cholinium ions (IIIw) are those in which R³ is selected from among methyl, ethyl, acetyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl and 14-ethoxy-5,10-oxatetradecyl.

Very particularly preferred phosphonium ions (IIIx) are those in which
R¹ to R³ are each, independently of one another, C₁-C₁₈-alkyl, in particular butyl, isobutyl, 1-hexyl or 1-octyl.

Among the abovementioned heterocyclic cations, preference is given to the pyridinium ions, pyrazolinium ions, pyrazolium ions and the imidazolinium ions and the imidazolium ions. Preference is also given to ammonium ions.

Particular preference is given to 1-methylpyridinium, 1-ethylpyridinium, 1-(1-butyl)-pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexa-decyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium, 1-(1-octyl)-2-methyl-3-ethylpyridinium, 1-(1-dodecyl)-2-methyl-3-ethylpyridinium, 1-(1-tetradecyl)-2-methyl-3-ethylpyridinium, 1-(1-hexadecyl)-2-methyl-3-ethylpyridinium, 1-methylimidazolium, 1-ethylimidazolium, 1-(1-butyl)-imidazolium, 1-(1-octyl)-imidazolium, 1-(1-dodecyl)-imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-hexyl)-3-methylimidazolium, 1-(1-octyl)-3-methylimidazolium, 1-(1-dodecyl)-3-methylimidazolium, 1-(1-tetradecyl)-3-methylimidazolium, 1-(1-hexadecyl)-3-methylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium and 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

As anions, it is in principle possible to use all anions.

The anions [Y]ⁿ⁻ of the ionic liquid is, for example, selected from among
the group of halides and halogen-comprising compounds of the formulae:
   F—, Cl—, Br—, I—, BF₄—, PF₆—, CF₃SO₃—, (CF₃SO₃)₂N—, CF₃CO₂—, CCl₃CO₂—, CN—, SCN—, OCN—
the group of sulfates, sulfites and sulfonates of the general formulae:
   SO₄²—, HSO₄—, SO₃²—, HSO₃—, R^{a}OSO₃—, R^{a}SO₃—
the group of phosphates of the general formulae
   PO₄³—, HPO₄²—, H₂PO₄—, R^{a}PO₄²—, HR^{a}PO₄—, R^{a}R^{b}PO₄—
the group of phosphonates and phosphinates of the general formulae:
   R^{a}HPO₃—, R^{a}R^{b}PO₂—, R^{a}R^{b}PO₃—
the group of phosphites of the general formulae:
   PO₃³—, HPO₃²—, H₂PO₃—, R^{a}PO₃²—, R^{a}HPO₃—, R^{a}R^{b}PO₃—
the group of phosphonites and phosphinites of the general formulae:
   R^{a}R^{b}PO₂—, R^{a}HPO₂—, R^{a}R^{b}PO—, R^{a}HPO—
the group of carboxylic acids of the general formula:
   R^{a}COO—
the group of borates of the general formulae:
   BO₃³—, HBO₃²—, H₂BO₃—, R^{a}R^{b}BO₃—, R^{a}HBO₃—, R^{a}BO₃²—, B(OR^{a})(OR^{b})(OR^{c})(OR^{d})—, B(HSO₄)—, B(R^{a}SO₄)—
the group of boronates of the general formulae:
   R^{a}BO₂²—, R^{a}R^{b}BO—
the group of silicates and silicic esters of the general formulae:
   SiO₄⁴—, HSiO₄³—, H₂SiO₄²—, H₃SiO₄—, R^{a}SiO₄³—, R^{a}R^{b}SiO₄²—, R^{a}R^{b}R^{c}SiO₄—, HR^{a}SiO₄²—, H₂R^{a}SiO₄—, HR^{a}R^{b}SiO₄—
the group of alkylsilane and arylsilane salts of the general formulae:
   R^{a}SiO₃³—, R^{a}R^{b}SiO₂²—, R^{a}R^{b}R^{c}SiO—, R^{a}R^{b}R^{c}SiO₃—, R^{a}R^{b}R^{c}SiO₂—, R^{a}R^{b}SiO₃²—
the group of carboximides, bis(sulfonyl)imides and sulfonylimides of the general formulae:

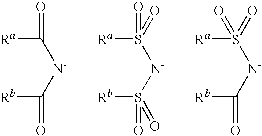

the group of methides of the general formula:

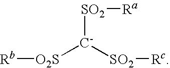

Here, R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-comprising heterocycle, where two of them may also together form an unsaturated, saturated or aromatic ring which may optionally be interrupted by one or more oxygen and/or sulfur atoms and/or one or more unsubstituted or substituted imino groups, where the radicals mentioned may each be additionally substituted by suitable functional groups, aryl, alkyl, aryloxy, alkyloxy, halogen, heteroatoms and/or heterocycles.

Here, C₁-C₁₈-alkyl which may optionally be substituted by suitable functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hetadecyl, octadecyl, 1,1-dimethylpropyl, 1,1-dimethylbutyl, 1,1,3,3-tetramethylbutyl, benzyl, 1-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-dimethylaminoethyl, 2-dimethylaminopropyl, 3-dimethylaminopropyl, 4-dimethylaminobutyl, 6-dimethylaminohexyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

C₂-C₁₈-alkyl which may optionally be interrupted by one or more nonadjacent oxygen and/or sulfur atoms and/or one or more substituted or unsubstituted imino groups is, for example, 5-methoxy-3-oxapentyl, 8-methoxy-3,6-dioxa-octyl, 11-methoxy-3,6,9-trioxaundecyl, 7-methoxy-4-oxaheptyl, 11-methoxy-4,8-dioxa-undecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two radicals form a ring, these radicals can together form as fused-on building block, for example, 1,3-propylene, 1,4-butylene, 2-oxa-1,3-propylene, 1-oxa-1,3-propylene, 2-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The number of nonadjacent oxygen and/or sulfur atoms and/or imino groups is in principle not subject to any restrictions or is automatically restricted by the size of the radical or the cyclic building block. In general, there will be no more than 5 in the respective radical, preferably no more than 4 and very particularly preferably no more than 3. Furthermore, there is generally at least one carbon atom, preferably at least two carbon atoms, between any two heteroatoms.

Substituted and unsubstituted imino groups can be, for example, imino, methylimino, isopropylamino, n-butylimino or tert-butylimino.

The term “functional groups” refers, for example, to the following: N,N-di(C₁-C₄-alkyl) carboxamide, di-(C₁-C₄-alkyl)amino, C₁-C₄-alkyloxycarbonyl, cyano or C₁-C₄-alkoxy. Here, C₁-C₄-alkyl is methyl, ethyl, propyl, isopropyl, n-butyl, sec-butyl or tert-butyl.

C₆-C₁₄-aryl which may optionally be substituted by suitable functional groups, aryl, alkyl, aryloxy, alkyloxy, halogen, heteroatoms and/or heterocycles is, for example, phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

C₅-C₁₂-cycloalkyl which may optionally be substituted by suitable functional groups, aryl, alkyl, aryloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

A five- or six-membered, oxygen-, nitrogen- and/or sulfur-comprising heterocycle is, for example, furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl.

Preferred anions are selected from the group of halides and halogen-comprising compounds, the group of sulfates, sulfites and sulfonates, the group of phosphates and the group of carboxylic acids, in particular from the group of halides and halogen-comprising compounds, the group of carboxylic acids, the group consisting of SO₄²—, SO₃²—, R^{a}OSO₃— and R^{a}SO₃— and the group consisting of PO₄³— and R^{a}R^{b}PO₄—, especially preferably from the group of halides and halogen-comprising compounds.

Preferred anions are, in particular, halides such as chloride, bromide, iodide, SCN—, OCN—, CN—, acetate, propionate, benzoate, C₁-C₄-alkylsulfates, R^{a}—COO—, R^{a}SO₃—, R^{a}R^{b}PO₄—, methanesulfonate, tosylate or di(C₁-C₄-alkyl)phosphates.

Particularly preferred anions are Cl—, CH₃COO—, C₂H₅COO—, C₆H₅COO—, CH₃SO₃—, (CH₃O)₂PO₂— and (C₂H₅O)₂PO₂—.

An especially preferred anion is chloride.

In a further preferred embodiment, ionic liquids of the formula I in which
[A]ₙ⁺ is 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methyl-imidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethyl-imidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium; and
[Y]ₙ₊ is Cl—, CH₃COO—, C₂H₅COO—, C₆H₅COO—, CH₃SO₃—, (CH₃O)₂PO₂— or (C₂H₅O)₂PO₂—;
   are used.

In a further preferred embodiment, ionic liquids whose anions are selected from the group consisting of HSO₄—, HPO₄²—, H₂PO₄— and HR^{a}PO₄—; in particular HSO₄—, are used.

In particular, ionic liquids of the formula I in which
[A]ₙ⁺ is 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium or 1-(prop-1-en-3-yl)-3-methylimidazolium; and
[Y]ₙ⁺ is HSO₄—;
   are used.

In the process of the invention, use is made of one ionic liquid of the formula I or a mixture of ionic liquids of the formula I. Preference is given to using one ionic liquid of the formula I.

In a further embodiment of the invention, it is possible to use one ionic liquid of the formula II or a mixture of ionic liquids of the formula II. Preference is given to using one ionic liquid of the formula II.

In a further embodiment of the invention, it is possible to use a mixture of ionic liquids of the formulae I and II.

For the purposes of the present invention, vinyl ethers are vinyl ethers of the formula IV,

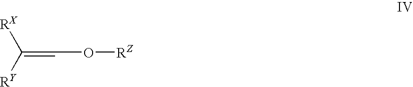

where the radicals have the following meanings:
R^{X}, R^{Y} are each hydrogen, C₁-C₃₀-alkyl, C₂-C₃₀-alkenyl, C₂-C₃₀-alkynyl, C₃-C₁₂-cycloalkyl, C₅-C₁₂-cycloalkenyl, aryl or heterocyclyl, where the last seven radicals may optionally be substituted;
R^{Z} is C₁-C₃₀-alkyl, C₂-C₃₀-alkenyl, C₂-C₃₀-alkynyl, C₃-C₁₂-cycloalkyl, C₅-C₁₂-cycloalkenyl, aryl or heterocyclyl, where these seven radicals may optionally be substituted;
   or
R^{X} and R^{Y} together form an optionally substituted —(CH₂)ₒ—Xₚ—(CH₂)_{q}— or —CH═CH—CH═CH— chain, where
   X is O, S, S(═O), S(═O)₂ or N(C₁-C₄-alkyl);
   o, q are each 1, 2, 3, 4, 5 or 6;
   p is 0 or 1;
      or

R^{X} and R^{Z} together form an optionally substituted —(CH₂)ᵣ—Yₛ—(CH₂)ₜ— chain, where
Y is O, S, S(═O), S(═O)₂ or N(C₁-C₄-alkyl);
r, t are each 1, 2, 3, 4, 5 or 6;
s is 0 or 1.

Optionally substituted C₁-C₃₀-alkyl radicals R^{X}, R^{Y} and R^{Z} are, in particular, unsubstituted C₁-C₃₀-alkyl radicals or C₁-C₃₀-alkyl radicals substituted by suitable functional groups, aryl, alkyl, aryloxy, alkyloxy, cycloalkyl, halogen, heteroatoms and/or heterocycles,

preferably C₁-C₃₀-alkyl radicals, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl and 1-eicosanyl, particularly preferably methyl, ethyl, 1-propyl, 1-butyl, 1-decyl, 1-dodecyl, 1-tetradecyl or 1-hexadecyl;
or
preferably C₁-C₃₀-alkyl radicals substituted by suitable functional groups, aryl, alkyl, aryloxy, alkyloxy, cycloalkyl, halogen, heteroatoms and/or heterocycles, for example cyanomethyl, 2-cyanoethyl, 2-cyanopropyl, methoxycarbonylmethyl, 2-methoxycarbonylethyl, ethoxycarbonylmethyl, 2-ethoxycarbonylethyl, 2-(butoxycarbonyl)ethyl, 2-butoxycarbonylpropyl, 1,2-di-(methoxycarbonyl)ethyl, formyl, dimethylaminomethyl, (2-dimethylaminoethyl, 2-dimethylaminopropyl, 3-dimethylaminopropyl, 4-dimethylaminobutyl, 6-dimethylaminohexyl)phenoxymethyl, 2-phenoxyethyl, 2-phenoxypropyl, 3-phenoxypropyl, 4-phenoxybutyl, 6-phenoxyhexyl, methoxymethyl, 2-methoxyethyl, 2-methoxypropyl, 3-methoxypropyl, 4-methoxybutyl, 6-methoxyhexyl, ethoxymethyl, 2-ethoxyethyl, 2-ethoxypropyl, 3-ethoxypropyl, 4-ethoxybutyl, 6-ethoxyhexyl, 2-butoxyethyl, 2-isopropoxyethyl, 2-butoxypropyl, 2-octyloxyethyl, 2-methoxyisopropyl, dimethoxymethyl, diethoxymethyl, 2,2-diethoxymethyl, 2,2-diethoxyethyl, acetyl, propionyl, CₘF_{2(m-a)+(1-b)}H_{2a+b} where m is from 1 to 30, 0≦a≦m and b=0 or 1 (for example CF₃, C₂F₅, CH₂CH₂—C₍ₘ₋₂₎F₂₍ₘ₋₂₎₊₁, C₆F₁₃, C₈F₁₇, C₁₀F₂₁, C₁₂F₂₅), chloromethyl, 2-chloroethyl, trichloromethyl, 1,1-dimethyl-2-chloroethyl, methylthiomethyl, ethylthiomethyl, butylthiomethyl, 2-dodecylthioethyl, 2-phenylthioethyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

Optionally substituted C₂-C₃₀-alkenyl radicals R^{X}, R^{Y} and R^{Z} are, in particular, unsubstituted C₂-C₃₀-alkenyl radicals or C₂-C₃₀-alkenyl radicals substituted by suitable functional groups, aryl, alkyl, aryloxy, alkyloxy, cycloalkyl, halogen, heteroatoms and/or heterocycles,
preferably C₂-C₃₀-alkenyl radicals, for example vinyl, 2-propenyl, 3-butenyl, cis-2-butenyl or trans-2-butenyl, particularly preferably vinyl or 2-propenyl;
   or
   preferably C₂-C₃₀-alkenyl radicals substituted by suitable functional groups, aryl, alkyl, aryloxy, alkyloxy, cycloalkyl, halogen, heteroatoms and/or heterocycles, for example CₘF_{2(m-a)-(1-b)}H_{2a-b} where m≦30, 0≦a≦m and b=0 or 1.

Optionally substituted C₂-C₃₀-alkynyl radicals R^{X}, R^{Y} and R^{Z} are, in particular, unsubstituted C₂-C₃₀-alkynyl radicals or C₂-C₃₀-alkynyl radicals substituted by suitable functional groups, aryl, alkyl, aryloxy, alkyloxy, cycloalkyl, halogen, heteroatoms and/or heterocycles;

preferably C₂-C₃₀-alkynyl radicals such as ethynyl, 1-propyn-3-yl, 1-propyn-1-yl or 3-methyl-1-propyn-3-yl, particularly preferably ethynyl or 1-propyn-3-yl.

Optionally substituted C₃-C₁₂-cycloalkyl radicals R^{X}, R^{Y} and R^{Z} are, in particular, unsubstituted C₃-C₈-cycloalkyl radicals or C₃-C₁₂-cycloalkyl radicals substituted by suitable functional groups, aryl, alkyl, aryloxy, alkyloxy, cycloalkyl, halogen, heteroatoms and/or heterocycles,

preferably C₃-C₁₂-cycloalkyl radicals, for example cyclopropyl, cyclobutyl, cyclopentyl, cyclohexyl, cyclooctyl, cyclododecyl, methylcyclopentyl, dimethylcyclopentyl, methylcyclohexyl, dimethylcyclohexyl, diethylcyclohexyl or butylcyclohexyl, and also bicyclic systems such as norbornyl, preferably cyclopentyl or cyclohexyl;
or
preferably C₃-C₁₂-cycloalkyl radicals substituted by suitable functional groups, aryl, alkyl, aryloxy, alkyloxy, cycloalkyl, halogen, heteroatoms and/or heterocycles, for example methoxycyclohexyl, dimethoxycyclohexyl, diethoxycyclohexyl, butylthiocyclohexyl, chlorocyclohexyl, dichlorocyclohexyl, dichlorocyclopentyl, CₘF_{2(m-a)-(1-b)}H_{2a-b} where m≦30, 0≦a≦m and b=0 or 1.

Optionally substituted C₅-C₁₂-cycloalkenyl radicals R^{X}, R^{Y} and R^{Z} are, in particular unsubstituted C₃-C₈-cycloalkenyl radicals or C₃-C₈-cycloalkenyl radicals substituted by suitable functional groups, aryl, alkyl, aryloxy, alkyloxy, cycloalkyl, halogen, heteroatoms and/or heterocycles,

preferably C₃-C₈-cycloalkenyl radicals, for example 3-cyclopentenyl, 2-cyclohexenyl, 3-cyclohexenyl, 2,5-cyclohexadienyl, and also bicyclic systems such as norbornyl, particularly preferably 3-cyclopentenyl, 2-cyclohexenyl or 3-cyclohexenyl;
or
preferably C₃-C₈-cycloalkenyl radicals substituted by suitable functional groups, aryl, alkyl, aryloxy, alkyloxy, cycloalkyl, halogen, heteroatoms and/or heterocycles, for example CₙF_{2(m-a)-3(1-b)}H_{2a-3b} where m≦12, 0≦a≦m and b=0 or 1.

Optionally substituted aryl radicals R^{X}, R^{Y} and R^{Z} are, in particular, unsubstituted C₆-C₁₂-aryl radicals or C₆-C₁₂-aryl radicals substituted by suitable functional groups, aryl, alkyl, aryloxy, alkyloxy, cycloalkyl, halogen, heteroatoms and/or heterocycles, preferably C₆-C₁₂-aryl radicals, for example phenyl, α-naphthyl or β-naphthyl, particularly preferably phenyl;

or
preferably C₆-C₁₂-aryl radicals substituted by suitable functional groups, aryl, alkyl, aryloxy, alkyloxy, cycloalkyl, halogen, heteroatoms and/or heterocycles, e.g. tolyl, xylyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl or tert-butylthiophenyl or C₆F₍₅₋ₐ₎Hₐ where 0≦a≦5, particularly preferably 4-tolyl.

Optionally substituted heterocyclyl radicals are, in particular, unsubstituted heteroaryl radicals or heteroaryl radicals substituted by suitable functional groups, aryl, alkyl, aryloxy, alkyloxy, cycloalkyl, halogen, heteroatoms and/or heterocycles, preferably 5- or 6-membered heteroaryl radicals comprising oxygen, nitrogen and/or sulfur atoms, e.g. furyl, thiophenyl, pyrryl, pyridyl, indolyl, benzoxazolyl, dioxolyl, dioxyl, benzimidazolyl or benzthiazolyl;

or
preferably 5- or 6-membered heteroaryl radicals which comprise oxygen, nitrogen and/or sulfur atoms and are substituted by suitable functional groups, aryl, alkyl, aryloxy, alkyloxy, cycloalkyl, halogen, heteroatoms and/or heterocycles, e.g. methylpyridyl, dimethylpyridyl, methylquinolyl, dimethylpyrryl, methoxyfuryl, dimethoxypyridyl, chloropyridyl or difluoropyridyl.

If R^{X} and R^{Y} together form an optionally substituted —(CH₂)ₒ−Xₚ—(CH₂)_{q}— or —CH═CH—CH═CH— chain, preference is given to a —(CH₂)ₒ—Xₚ−(CH₂)_{q}— or —CH═CH—CH═CH— chain, in particular a —(CH₂)ₒ—(CH₂)_{q}— chain, in particular —(CH₂)₅— or —(CH₂)₆—,

or
a C₁-C₄-alkyl-substituted —(CH₂)ₒ−Xₚ—(CH₂)_{q}— or C₁-C₄-alkyl-substituted —CH═CH—CH═CH— chain, in particular a C₁-C₄-alkyl-substituted —(CH₂)ₒ—(CH₂)_{q}— chain, in particular a C₁-C₄-alkyl-substituted —(CH₂)₅— or —(CH₂)₆— chain.

If R^{X} and R^{Z} together form an optionally substituted —(CH₂)ᵣ—Yₛ—(CH₂)ₜ— chain, preference is given to a —(CH₂)ᵣ—Xₛ—(CH₂)ₜ— chain, particularly preferably a —(CH₂)ᵣ—(CH₂)ₜ— chain, in particular —(CH₂)₂—, —(CH₂)₃— or —(CH₂)₄—, especially preferably —(CH₂)₃—,

or
a C₁-C₄-alkyl-substituted —(CH₂)ᵣ—Yₛ—(CH₂)ₜ— chain, particularly preferably a C₁-C₄-alkyl-substituted —(CH₂)ᵣ—(CH₂)ₜ— chain, in particular a C₁-C₄-alkyl-substituted —(CH₂)₂—, —(CH₂)₃— or —(CH₂)₄— chain, especially preferably a C₁-C₄-alkyl-substituted —(CH₂)₃— chain.

In an embodiment of the present invention, vinyl ethers of the formula IV in which the radicals have the following meanings:
R^{X} is hydrogen or C₁-C₁₈-alkyl, preferably hydrogen or C₁-C₆-alkyl; particularly preferably hydrogen, methyl or ethyl; especially preferably hydrogen;
R^{Y} is hydrogen;
R^{Z} is C₁-C₁₈-alkyl, preferably C₁-C₆-alkyl; particularly preferably methyl, ethyl, 1-propyl, 2-propyl, 1-butyl, 2-butyl, 2-methyl-1-propyl, 2-methyl-2-propyl,
   are used.

In a further embodiment, vinyl ethers of the formula IV in which the radicals have the following meanings:
R^{X} is 1-decyl, 1-dodecyl, 1-tetradecyl or 1-hexadecyl;
R^{Y} is hydrogen;
R^{Z} is C₁-C₁₈-alkyl, preferably C₁-C₆-alkyl; particularly preferably methyl, ethyl, 1-propyl, 2-propyl, 1-butyl, 2-butyl, 2-methyl-1-propyl, 2-methyl-2-propyl,
   are used.

In a further embodiment, vinyl ethers of the formula IV in which the radicals have the following meanings:
R^{X} and R^{Z} together form a —(CH₂)ᵣ—(CH₂)ₜ— chain, preferably a —(CH₂)₂—, —(CH₂)₃— or —(CH₂)₄— chain, particularly preferably a —(CH₂)₃— chain;
R^{Y} is hydrogen,
   are used.

In the acetalization according to the invention of cellulose, it is possible to use celluloses from a wide variety of sources, e.g. from cotton, flax, Ramie, straw, bacteria, etc., or from wood or Bagasse, in the cellulose-enriched form.

However, the process of the invention can be used not only for preparing cellulose acetals but also generally for preparing polysaccharide, oligosaccharide and disaccharide acetals and also derivatives thereof. Examples of polysaccharides include cellulose and hemicellulose and also starch, glycogen, dextran and tunicin. Further examples are the polycondensates of D-fructose, e.g. inulin, and also, inter alia, chitin, chitosan and alginic acid. Sucrose is an example of a disaccharide. Suitable cellulose derivatives are those whose DS is <3, including cellulose ethers such as methylcellulose and carboxymethylcellulose, cellulose esters such as cellulose acetate, cellulose butyrate, cellulose silyl ethers such as cellulose trimethylsilyl ether, and cellulose nitrate, in each case with a DS of <3. The corresponding statements apply analogously here.

In one embodiment of the present invention, a polysaccharide such as cellulose, hemicellulose, starch, glycogen, dextran, tunicin, inulin, chitin or alginic acid, preferably cellulose, is reacted by the process of the invention.

In a further embodiment of the present invention, a disaccharide such as sucrose is reacted by the process of the invention.

In a further embodiment of the present invention, a cellulose derivative whose DS is <3, e.g. a cellulose ether such as methylcellulose or carboxymethylcellulose, a cellulose ester such as cellulose acetate, cellulose butyrate, a cellulose silyl ether such as cellulose trimethylsilyl ether, or cellulose nitrate, in each case having a DS of <3, is reacted by the process of the invention. Preference is given here to using cellulose ethers such as methylcellulose and carboxymethylcellulose, cellulose esters such as cellulose acetate, cellulose butyrate and cellulose nitrate.

The reaction of cellulose with a vinyl ether of the formula IV to form corresponding cellulose acetals, which will for the purposes of the present invention also be referred to as “acetalization of cellulose”, can be shown schematically as follows, with “OH” being a hydroxyfunction of the cellulose and “Cell” being the remaining part of the cellulose molecule.

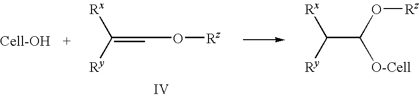

In the process of the invention, a solution of cellulose in an ionic liquid is prepared. The concentration of cellulose here can be varied within a wide range. It is usually in the range from 0.1 to 50% by weight, based on the total weight of the solution, preferably from 0.2 to 40% by weight, particularly preferably from 0.3 to 30% by weight and very particularly preferably from 0.5 to 20% by weight.

This dissolution procedure can be carried out at room temperature or with heating, but above the melting point or softening temperature of the ionic liquid, usually at a temperature of from 0 to 200° C., preferably from 20 to 180° C., particularly preferably from 50 to 150° C. However, it is also possible to accelerate dissolution by intensive stirring or mixing or by introduction of microwave or ultrasonic energy or by a combination of these.

The vinyl ether of the formula IV is then added to the resulting solution. The vinyl ether of the formula IV can be added as such or as a solution in an ionic liquid or a suitable solvent. Suitable solvents are, for example, ethers such as diethyl ether, methyl tert-butyl ether, tetrahydrofuran or dioxane, or ketones such as dimethyl ketone, or halogenated hydrocarbons such as dichloromethane, trichloromethane or dichloroethane. The amount of solvent used to dissolve the vinyl ether of the formula IV should be such that no precipitation of the cellulose occurs when the addition is carried out. Ionic liquids used are preferably those in which cellulose itself, as described above, is dissolved.

If the vinyl ether of the formula IV is gaseous, it can be introduced as gas into the solution of cellulose in the ionic liquid.

In a particular embodiment, the vinyl ether of the formula IV is added as such.

In a further particular embodiment, the vinyl ether of the formula IV is added as a solution in an ionic liquid, with particular preference being given to using the ionic liquid which is also used for dissolving the cellulose.

In another embodiment, the ionic liquid and the vinyl ether of the formula IV are premixed and the cellulose is dissolved in this mixture.

It is also possible for one or more further solvents to be added to the reaction mixture or be introduced together with the ionic liquid or the vinyl ether of the formula IV. Possible solvents here are solvents which do not adversely affect the solubility of the cellulose, for example aprotic dipolar solvents such as dimethyl sulfoxide, dimethylformamide, dimethylacetamide or sulfolane. Furthermore, nitrogen-comprising bases such as pyridine, etc., can be additionally added.

In a particular embodiment, the reaction mixture comprises, apart from the ionic liquid and any solvent in which the vinyl ether of the formula IV has been dissolved, less than 5% by weight, preferably less than 2% by weight, in particular less than 0.1% by weight, based on the total weight of the reaction mixture, of further solvents and/or additional nitrogen-comprising bases.

It is also possible to carry out the process of the invention in the presence of a catalyst. Suitable catalysts here are, for example, mercury(II) salts such as mercury(II) acetate, propionate, benzoate, chloride, sulfate and nitrate, or palladium(II) salts such as palladium(II) acetate, propionate, chloride, nitrate and benzoate and palladium(II) salts in admixture with 1,10-phenanthroline monohydrate. The catalyst is usually used in amounts of up to 20 mol %, preferably up to 5 mol %, based on the vinyl ether of the formula IV.

The reaction is, depending on the ionic liquid used and the reactivity of the vinyl ether of the formula IV used, usually carried out at a temperature from the melting point of the ionic liquid up to 200° C., preferably from 20 to 180° C., in particular from 50 to 150° C.

In the case of vinyl ethers of the formula IV which are liquid or solid at the reaction temperature, the reaction is usually carried out at ambient pressure. However, it can sometimes also be advantageous to carry it out under superatmospheric pressure, particularly when a volatile vinyl ether of the formula IV is used. In general, the reaction is carried out in air. However, it is also possible to carry it out under an inert gas, i.e., for example, under N₂, a noble gas or mixtures thereof.

In the case of vinyl ethers of the formula IV which are gaseous at the reaction temperature, it can be advantageous to carry out the reaction under the autogenous pressure of the reaction mixture at the desired reaction temperature or at a pressure which is higher than the autogenous pressure of the reaction system.

However, it can also be advantageous to carry out the reaction with a vinyl ether of the formula IV which is gaseous at the reaction temperature under ambient pressure and to use the gaseous vinyl ether of the formula IV in excess.

The amount of vinyl ether used, in each case relative to the cellulose used, the reaction time and, if appropriate, the reaction temperature are set as a function of the desired degree of substitution of the cellulose.

For example, if the cellulose which is made up of an average of u anhydroglucose units is to be completely acetalated, then 3 u equivalents of vinyl ether of the formula IV are required. Preference is here given to using the stoichiometric amount of vinyl ether of the formula IV (n_{vinyl ether}/n_{anhydroglucose units}=3) or an excess, preferably an excess of up to 1000 mol % based on u.

If the cellulose which is made up of an average of u anhydroglucose units is to be partially acetalated, then the amount of vinyl ether of the formula IV used is usually adapted accordingly (n_{vinyl ether}/n_{anhydroglucose units}<3). The smaller the ratio n_{vinyl ether}/n_{anhydroglucose units}, the smaller the average degree of substitution of the acetalated cellulose under otherwise identical conditions and identical reaction time.

Furthermore, it is possible to stop the acetalization reaction when the desired degree of acetalization has been reached by separating off the acetalated cellulose from the reaction mixture. This can be effected, for example, by addition of an excess of water or another suitable solvent in which the acetalated cellulose is not soluble but the ionic liquid is readily soluble, e.g. a lower alcohol such as methanol, ethanol, propanol or butanol, or a ketone, for example diethyl ketone, etc., or mixtures thereof. The choice of suitable solvent is also determined by the respective degree of substitution and the substituents on the cellulose. Preference is given to using an excess of water or methanol.

The reaction mixture is usually worked up by precipitating the acetalated cellulose as described above and filtering off the acetalated cellulose. The ionic liquid can be recovered from the filtrate by conventional methods, by distilling off the volatile components, e.g. the precipitant or excess vinyl ether of the formula IV or its hydrolysis products, etc. The ionic liquid which remains can be reused in the process of the invention. If a catalyst is used in the reaction, this usually remains in the liquid phase and is recycled together with the ionic liquid. In a further embodiment, excess vinyl ether of the formula IV can also remain in the ionic liquid and be reused in the process of the invention.

However, it is also possible to introduce the reaction mixture into water or into another suitable solvent in which the acetalated cellulose is not soluble but the ionic liquid is readily soluble, e.g. a lower alcohol such as methanol, ethanol, propanol or butanol, or a ketone, for example diethyl ketone, etc., or mixtures thereof and, depending on the embodiment, obtain, for example, fibers, films of acetalated cellulose. The choice of suitable solvent is also determined by the respective degree of substitution and the substituents of the cellulose. The filtrate is worked up as described above.

Furthermore, it is also possible to stop the acetalization reaction when the desired degree of acetalization has been reached by cooling the reaction mixture and working it up. The work-up can be carried out by the methods indicated above.

The acetalization reaction can also be stopped by removing vinyl ether of the formula IV still present from the reaction mixture by distillation, stripping or extraction with a solvent which forms two phases with the ionic liquid at a given point in time.

In a further embodiment of the present invention, two or more vinyl ethers of the formula IV ar reacted. In this case, it is possible to use a mixture of two (or more) vinyl ethers of the formula IV in a manner analogous to the above procedure. However, it is also possible firstly to carry out the reaction to a DS=a (<3) using the first vinyl ether of the formula IV and then carry out the reaction to a DS=b, where a<b≦3, using a second vinyl ether of the formula IV.

In this embodiment, acetalated celluloses in which OH groups of the cellulose have been replaced by two (or more) different O—CH(OR^{Z})(CHCR^{X}R^{Y}) groups (as a function of the vinyl ethers of the formula IV used).

If the ionic liquid is circulated, the ionic liquid can comprise up to 15% by weight, preferably up to 10% by weight, in particular up to 5% by weight, of precipitant(s) as described above. However, it can then be necessary, as the case may be, to use an appropriate excess of vinyl ethers of the formula IV.

The process can be carried out batchwise, semicontinuously or continuously.

The present invention also provides acetalated polysaccharides, oligosaccharides or disaccharides or derivatives thereof, in particular acetalated cellulose, which can be obtained by reaction of a polysaccharide, oligosaccharide or disaccharide or a derivative thereof, in particular cellulose, with a vinyl ether of the formula IV in which R^{X} and R^{Z} together form an optionally substituted —(CH₂)ᵣ—Yₛ—(CH₂)ₜ— chain, where
Y is O, S, S(═O), S(═O)₂ or N(C₁-C₄-alkyl);
r, t are each 1, 2, 3, 4, 5 or 6;
s is 0 or 1;
and
R^{Y} is hydrogen, C₁-C₃₀-alkyl, C₂-C₃₀-alkenyl, C₂-C₃₀-alkynyl, C₃-C₁₂-cycloalkyl, C₅-C₁₂-cycloalkenyl, aryl or heterocyclyl, where the last seven radicals may optionally be substituted;
   in an ionic liquid of the formula I or II or mixtures thereof.

The acetalated polysaccharides or oligosaccharides, in particular acetalated cellulose, which can be obtained by the process of the invention by acetalization of polysaccharides or oligosaccharides, in particular cellulose, by means of a vinyl ether of the formula IV are suitable, for example, for producing moldings, fibers and films and also coatings. It is particularly advantageous that the products can be processed in dissolved form and subsequently be converted into an insoluble, crosslinked form.

It is also possible to crosslink the acetalated polysaccharides or oligosaccharides, in particular acetalated celluloses, obtained by the abovementioned process by treating the acetalated polysaccharide or oligosaccharide, in particular the acetalated cellulose, with acid. As acids, it is possible to use inorganic or organic acids or mixtures thereof.

In one particular embodiment, this crosslinking utilizes acetalated cellulose obtained as described above by reaction of cellulose with a vinyl ether of the formula IV,

where the radicals have the following meanings:
R^{X}, R^{Y} are each hydrogen, C₁-C₃₀-alkyl, C₂-C₃₀-alkenyl, C₂-C₃₀-alkynyl, C₃-C₁₂-cycloalkyl, C₅-C₁₂-cycloalkenyl, aryl or heterocyclyl, where the last seven radicals may optionally be substituted;
R^{Z} is C₁-C₃₀-alkyl, C₂-C₃₀-alkenyl, C₂-C₃₀-alkynyl, C₃-C₁₂-cycloalkyl, C₅-C₁₂-cycloalkenyl, aryl or heterocyclyl, where these seven radicals may optionally be substituted;
   or
R^{X} and R^{Y} together form an optionally substituted —(CH₂)ₒ—Xₚ—(CH₂)_{q}— or —CH═CH—CH═CH— chain, where
   X is O, S, S(═O), S(═O)₂ or N(C₁-C₄-alkyl);
   o, q are each 1, 2, 3, 4, 5 or 6;
   p is 0 or 1.

In one particular embodiment, this crosslinking utilizes acetalated cellulose obtained by reaction of cellulose with a vinyl ether of the formula IV, where the radicals have the following meanings:
R^{X} is hydrogen or C₁-C₁₈-alkyl, preferably hydrogen or C₁-C₆-alkyl; more preferably hydrogen, methyl or ethyl; extremely preferably hydrogen;
R^{Y} is hydrogen;
R^{Z} is C₁-C₁₈-alkyl, preferably C₁-C₆-alkyl; more preferably methyl, ethyl, 1-propyl, 2-propyl, 1-butyl, 2-butyl, 2-methyl-1-propyl, 2-methyl-2-propyl.

In a further particular embodiment, this crosslinking utilizes acetalated cellulose obtained by reaction of cellulose with a vinyl ether of the formula IV, where the radicals have the following meanings:
R^{X} is 1-decyl, 1-dodecyl, 1-tetradecyl or 1-hexadecyl;
R^{Y} is hydrogen;
R^{Z} is C₁-C₁₈-alkyl, preferably C₁-C₆-alkyl; more preferably methyl, ethyl, 1-propyl, 2-propyl, 1-butyl, 2-butyl, 2-methyl-1-propyl, 2-methyl-2-propyl.

Examples of inorganic acids are hydrohalic acids such as HF, HCl, HBr or HI, perhalic acids such as HClO₄, halic acids such as HClO₃, sulfur-comprising acids such as H₂SO₄, polysulfuric acid or H₂SO₃, nitrogen-comprising acids such as HNO₃, or phosphorus-comprising acids such as H₃PO₄, polyphosphoric acid or H₃PO₃. Preference is given to using hydrohalic acids such as HCl or HBr, H₂SO₄,HNO₃ or H₃PO₄, in particular HCl, H₂SO₄ or H₃PO₄.

Examples of organic acids are carboxylic acids such as
C₁-C₆-alkanecarboxylic acids, for example acetic acid, propionic acid, n-butanecarboxylic acid or pivalic acid,
dicarboxylic or polycarboxylic acids, for example succinic acid, maleic acid or fumaric acid,
hydroxycarboxylic acids, for example hydroxyacetic acid, lactic acid, maleic acid or citric acid,
halogenated carboxylic acids, for example C₁-C₆-haloalkanecarboxylic acids, e.g. fluoroacetic acid, chloroacetic acid, bromoacetic acid, difluoroacetic acid, dichloroacetic acid, chlorofluoroacetic acid, trifluoroacetic acid, trichloroacetic acid, 2-chloropropionic acid, perfluoropropionic acid or perfluorobutanecarboxylic acid,
aromatic carboxylic acids, for example arylcarboxylic acids such as benzoic acid;
   or sulfonic acids such as
C₁-C₆-alkanesulfonic acids, for example methanesulfonic acid or ethanesulfonic acid,
halogenated sulfonic acids, for example C₁-C₆-haloalkanesulfonic acids such as trifluoromethanesulfonic acid,
aromatic sulfonic acids, for example arylsulfonic acids such as benzenesulfonic acid or 4-methylphenylsulfonic acid.

As organic acids, preference is given to using C₁-C₆-alkanecarboxylic acids, for example acetic acid or propionic acid, halogenated carboxylic acids for example C₁-C₆-haloalkanecarboxylic acids, e.g. fluoroacetic acid, chloroacetic acid, difluoroacetic acid, dichloroacetic acid, chlorofluoroacetic acid, trifluoroacetic acid, trichloroacetic acid or perfluoropropionic acid, or sulfonic acids such as C₁-C₆-alkanesulfonic acids, for example methanesulfonic acid or ethanesulfonic acid, halogenated sulfonic acids, for example C₁-C₆-haloalkanesulfonic acids such as trifluoromethanesulfonic acid, or arylsulfonic acids such as benzenesulfonic acid or 4-methylphenylsulfonic acid. Preference is given to using acetic acid, chlorofluoroacetic acid, trifluoroacetic acid, perfluoropropionic acid, methanesulfonic acid, trifluoromethanesulfonic acid or 4-methylphenylsulfonic acid.

Crosslinking can be effected in various ways.

In one embodiment, the cellulose acetal is applied as such to an inert surface, e.g. as a film, and then treated with the vapor of an appropriate acid by allowing, for example, vapors of acetic acid, HCl gas, etc., to flow over this surface coated with cellulose acetal. The concentration of the acid and the treatment time and the treatment temperature are set as a function of the desired degree of crosslinking. When the desired degree of crosslinking has been reached, the resulting crosslinked cellulose is rinsed with a solvent in which it is not soluble. Water or, for example, a lower alcohol such as methanol, ethanol, propanol or butanol or a ketone, for example diethyl ketone, etc., or mixtures thereof are suitable for this purpose. This rinsing procedure can be carried out on the inert surface used at the beginning, but it is also possible to take the shaped body obtained off from the inert surface and then to rinse the shaped body.

In another embodiment, the cellulose acetal is dissolved in a solvent in which it is soluble. Solvents suitable for this purpose are ionic liquids in general as described at the outset. However, depending on the type of acetal, the DS and the DP of the acetalated cellulose, it can also be possible to use solvents such as aromatic hydrocarbons such as benzene, chlorinated hydrocarbons such as methylene chloride, chloroform, 1,2-dichloroethane, ketones such as acetone, diethyl ketone or ethers such as tetrahydrofuran or dioxane. The acid is then added as such or as a solution to this solution. The crosslinked cellulose usually precipitates here. Should this not be the case, a solvent in which the crosslinked cellulose is not soluble is added. Solvents suitable for this purpose are, in particular, water and lower alcohols such as methanol, ethanol, propanol or butanol, in particular methanol.

In a particular embodiment of the present invention, the reaction mixture obtained in the reaction of cellulose with a vinyl ether of the formula VI is treated with acid as described above.

In a further embodiment, the cellulose acetal is dissolved in a solvent in which it is soluble, as described above. This solution is then introduced into water or into another suitable solvent in which the crosslinked cellulose is not soluble but the solvent is readily soluble, e.g. a lower alcohol such as methanol, ethanol, propanol or butanol or a ketone, for example diethyl ketone, etc., or mixtures thereof and to which acid has been added, and, depending on the embodiment, obtained, for example, fibers, films, etc., of crosslinked cellulose.

In a particular embodiment of the present invention, the reaction mixture obtained in the reaction of cellulose with a vinyl ether of the formula IV is treated with acid as described above.

The amount of acid used is in the range from 0.001 to 10 mol %, based on the number of anhydroglucose units of the cellulose acetal used. Preference is given to using catalytic amounts, in particular from 0.1 to 0.001 mol %.

This crosslinking is usually carried out at a temperature up to 200° C., preferably in the range from 0 to 150° C., in particular in the range from 10 to 100° C. In a particular embodiment, this crosslinking is carried out at room temperature.

The crosslinked cellulose obtained by this process is novel and is likewise provided by the present invention.

The crosslinking of the acetalated cellulose, as described above, can lead to the formation of (a) intermolecular acetals, which accordingly bond various “cellulose chains” together, and/or to the formation of (b) intramolecular acetals, i.e. the formation of acetals between various anhydroglucose units of a “cellulose chain”. This may be illustrated by the diagram below, where R represents H or CH(OR^{z})—CHR^{x}R^{y} and where the intermolecular or intramolecular bridging is not fixed to the exemplified positions, but can also take place at other positions of the particular anhydroglucose unit:

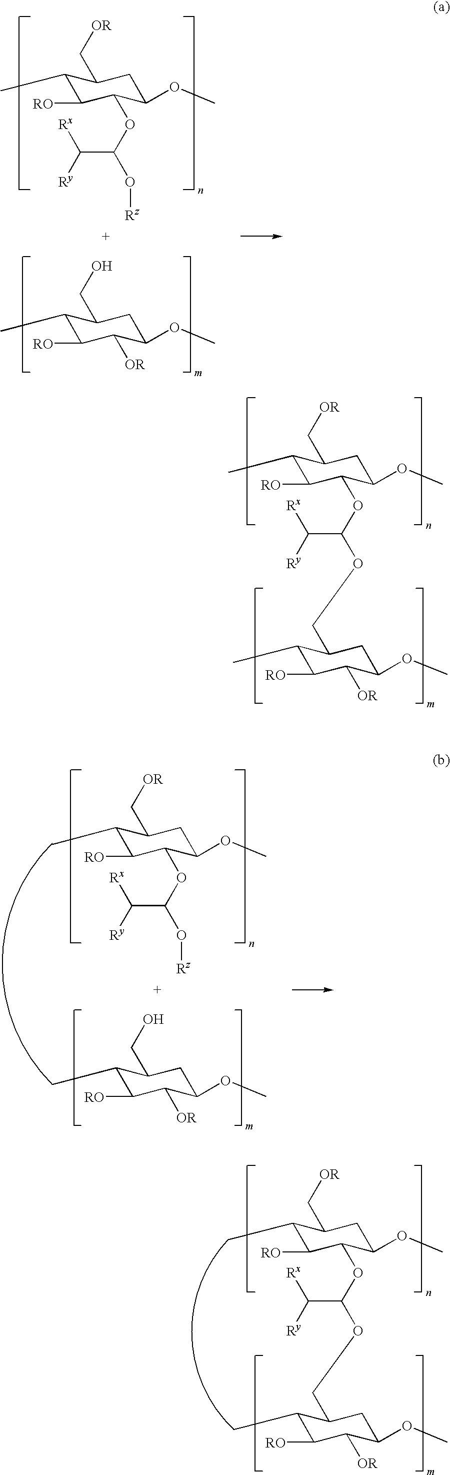

The following examples illustrate the invention.

### Preliminary Remark:

Avicel PH 101 (microcrystalline cellulose; DP=463) was dried overnight at 105° C. and 0.05 mbar.

The ionic liquid was dried overnight at 120° C. and 0.05 mbar while stirring.

All examples were carried out in an atmosphere of water-free argon.

The average degree of substitution DS of the acetalated cellulose was determined by means of elemental analysis.

### Abbreviations:

BMIM Cl 1-butyl-3-methylimidazolium chloride
BMMIM Cl 1-butyl-2,3-dimethylimidazolium chloride
DHP 3,4-dihydro(2H)pyran
AGU anhydroglucose unit
DS average degree of substitution

### EXAMPLE 1

### General Method

From 5 to 15 ml of BMIM Cl were placed in a 25 ml flask and Avicel PH 101 was added at the temperature reported in table 1 while stirring. After a clear solution had been obtained, vinyl ether and, if appropriate, catalyst were added at this temperature. After the reaction mixture had been stirred at this temperature for the time reported in table 1, the mixture was cooled and methanol was introduced while stirring vigorously. The precipitate which formed was filtered off with suction and dried at 70° C. and 0.05 mbar.

TABLE 1

| | Amount of | n_{(AGU)}: | | | | | | |
|---|---|---|---|---|---|---|---|---|
| Vinyl ether | vinyl ether | n_{(vinyl ether)} | | Temp. | Reaction | Yield | | |
| (IV) | [mmol] | [mol/mol] | Cat. | [° C.] | time [h] | [%.] | DS | Solubility |
| Ethenyl | 62.90 | 1:19 | Pd^{a)} | 80 | 29 | 71.4 | 2.32 | CHCl₃ |
| n-butyl ether | | | | | | | | |
| Ethenyl | 38.44 | 1:18 | Hg^{b)} | 90 | 74 | 82.6 | 2.24 | |
| n-butyl ether | | | | | | | | |
| Ethenyl iso- | 73.00 | 1:18 | Pd^{a)} | 80 | 73 | 59.1 | 2.31^{c)} | CHCl₃ |
| butyl ether | | | | | | | | |
| DHP | 54.68 | 1:15 | — | 90 | 51 | 54.5 | 1.69^{c)} | CHCl₃ |
| Ethenyl | 5.09 | 1:3 | Pd^{a}) | 80 | 12 | 74.7 | 1.10^{c)} | CH₃OH |
| n-butyl ether^{d)} | | | | | | | | |
| Ethenyl | 5.99 | 1:3 | Hg^{b)} | 80 | 18 | 71.2 | 1.51^{c)} | CH₃OH |
| n-butyl ether^{d)} | | | | | | | | |

^{a)}5 mol % based on AGUs of Pd(II) acetate + 5 mol % based on AGUs of 1,10-phenanthroline monohydrate
^{b)}5 mol % based on AGUs of Hg(II) acetate
^{c)}DS determined by NMR spectroscopy
^{d)}In this example, the work-up was carried out using water instead of methanol.

### EXAMPLE 2

0.5 g of the product from example 1, experiment 6 (last line of table 1) was dissolved in 10 ml of methanol at room temperature. 0.01 g of 96% strength sulfuric acid was added at this temperature. During stirring, a white precipitate was immediately formed. After 2 hours, this was filtered off with suction, washed three times with 20 ml each time of methanol and dried to constant weight at 60° C. and 0.05 mbar. The product is insoluble in all customary solvents (tetrahydrofuran, dioxane, toluene, ethyl acetate, dimethylformamide, dimethyl sulfoxide, methanol, etc.). According to elemental analysis, the product is cellulose having 1.5 (>CH—CH3) bridges per AGU.

### EXAMPLE 3

A round-bottom flask was charged with BMMIM Cl and Avicel PH 101 was added at 120° C. while stirring. After a clear solution had been obtained, 16.55 mmol of DHP were added at 120° C. (n_{(AGU)}: n_{(vinyl ether)}[mol/mol]=1:5) and also 5 mol %, based on AGU, of Pd(II) acetate and 5 mol %, based on AGU, of 1,10-phenanthroline monohydrate. After the reaction mixture had been stirred at 120° C. for 4 hours, the mixture was cooled and methanol was introduced while stirring vigorously. The precipitate which formed was filtered off with suction and dried at 70° C. and 0.05 mbar. The cellulose acetal thus obtained has a DS (determined by NMR spectroscopy) of 0.6 and is soluble in dimethyl sulfoxide.

1. A process for the acetalization of polysaccharides, oligosaccharides or disaccharides or derivatives thereof comprising dissolving a polysaccharide, oligosaccharide or disaccharide or the corresponding derivative in at least one ionic liquid and reacting it with a vinyl ether.

2. The process according to claim 1, wherein the polysaccharide, oligosaccharide or disaccharide or derivative thereof is a polysaccharide or a derivative thereof.

3. The process according to claim 2, wherein the polysaccharide or derivative thereof is cellulose or a cellulose derivative.

4. The process according to claim 3, wherein the polysaccharide or derivative thereof is cellulose.

5. The process according to claim 1, wherein the ionic liquid or mixture thereof is selected from among the compounds of the formula I,
[A]ₙ⁺[Y]ₙ₋ (I),
where
n is 1, 2, 3 or 4;
[A]⁺ is a quaternary ammonium cation, an oxonium cation, a sulfonium cation or a phosphonium cation; and
[Y]ⁿ⁻ is a monovalent, divalent, trivalent or tetravalent anion;
or
the compounds of the formula II
[A¹]⁺[A²]+[Y]ⁿ⁻ (IIa), where n=2;
[A¹]⁺[A²]⁺[A³]⁺[Y]ⁿ⁻ (IIb), where n=3; or
[A¹]⁺[A²]⁺[A³]⁺[A⁴]⁺[Y]ⁿ⁻ (IIc), where n=4,
where
[A¹]⁺, [A²]⁺, [A³]⁺ and [A⁴]⁺ are selected independently from among the groups mentioned for [A]⁺; and
[Y]ⁿ⁻ is as defined above.

6. The process according to claim 5, wherein [A]⁺ is a cation selected from among the compounds of the formulae (IIIa) to (IIIy) 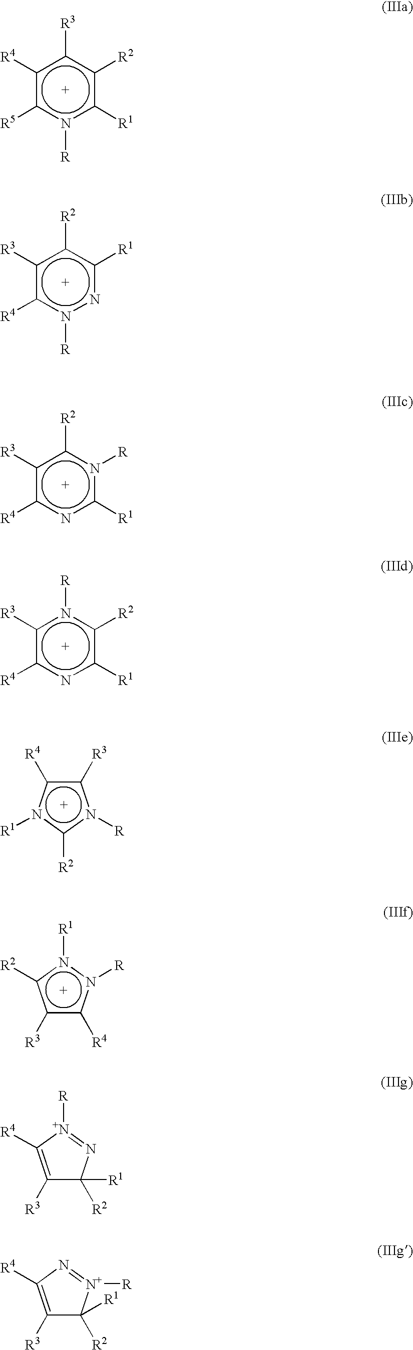 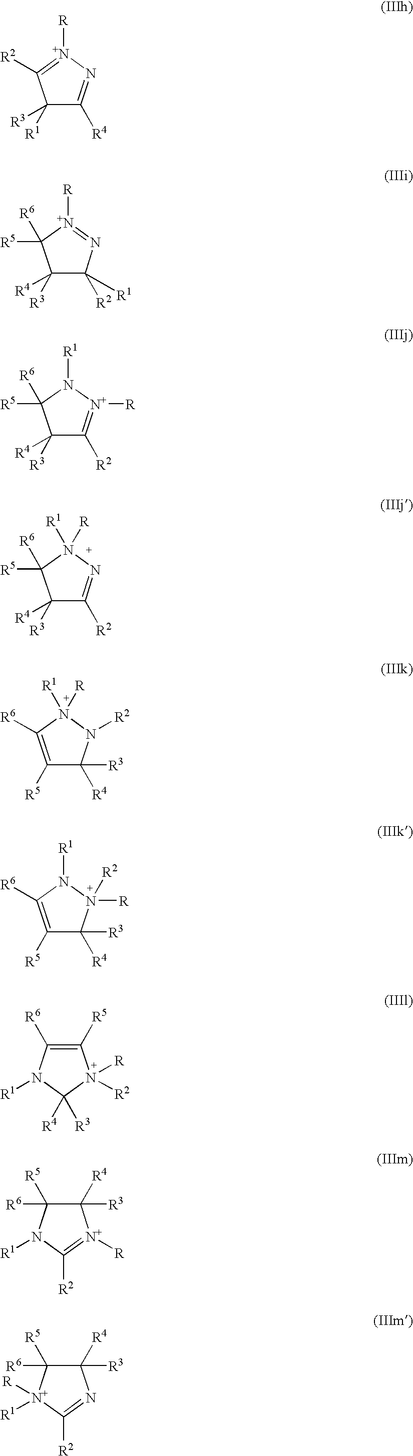 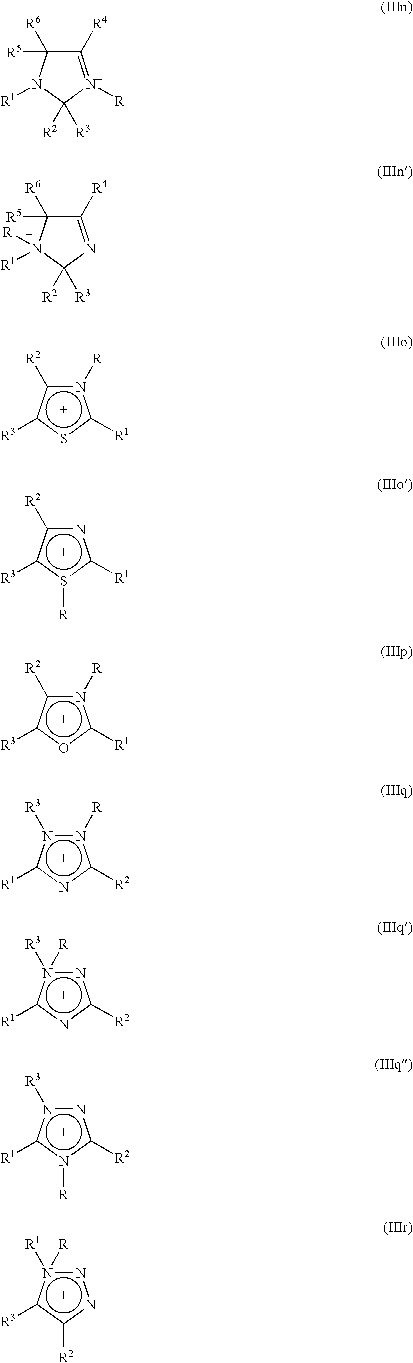 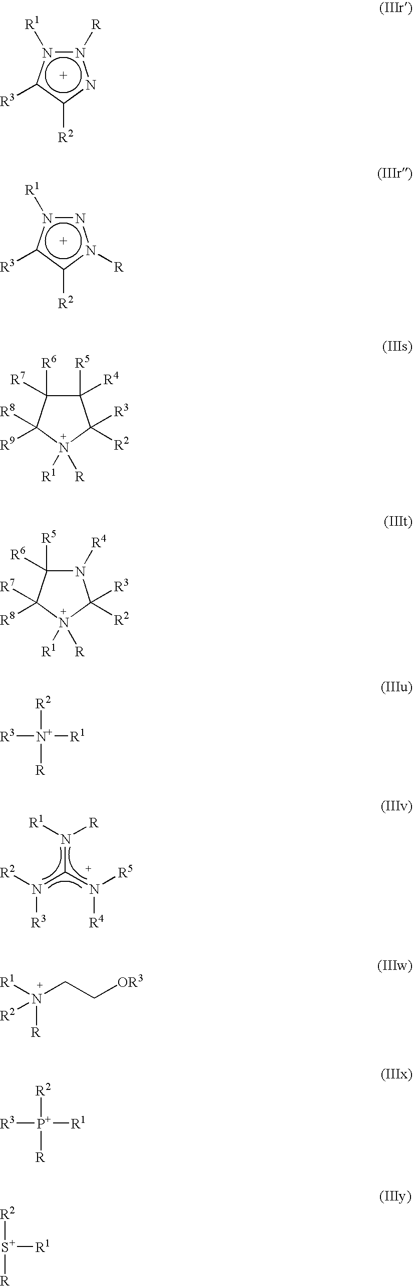
and oligomers comprising these structures, where
the radical R is hydrogen or a carbon-containing organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or suitable functional groups; and
the radicals R¹ to R⁹ are each, independently of one another, hydrogen, a sulfo group or a carbon-containing organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or suitable functional groups, where the radicals R¹ to R⁹ which are bound to a carbon atom (and not to a heteroatom) in the formulae (III) mentioned above are additionally able to be halogen or a suitable functional group; or
two adjacent radicals from the group consisting of R¹ to R⁹ may together also form a divalent, carbon-containing organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or suitable functional groups;
where, when [A]⁺ is IIIw, then R³ is not hydrogen.

7. he process according to claim 5, wherein [Y]ⁿ⁻ is an anion selected from
the group of halides and halogen-containing compounds of the formulae:
F⁻, Cl⁻, Br⁻, I⁻, BF₄⁻, PF₆⁻, CF₃SO₃⁻, (CF₃SO₃)₂N⁻, CF₃CO₂⁻, CCl₃CO₂⁻, CN⁻, SCN⁻, OCN⁻
the group of sulfates, sulfites and sulfonates of the general formulae:
SO₄²⁻, HSO₄⁻, SO₃²⁻, HSO₃⁻, R^{a}OSO₃⁻, R^{a}SO₃⁻
the group of phosphates of the general formulae
PO₄³⁻, HPO₄²⁻, H₂PO₄⁻, R^{a}PO₄²⁻, HR^{a}PO₄⁻, R^{a}R^{b}PO₄⁻
the group of phosphonates and phosphinates of the general formulae:
R^{a}HPO₃⁻, R^{a}R^{b}PO₂⁻, R^{a}R^{b}PO₃⁻
the group of phosphites of the general formulae:
PO₃³⁻, HPO₃²⁻, H₂PO₃⁻, R^{a}PO₃²⁻, R^{a}HPO₃⁻, R^{a}R^{b}PO₃⁻
the group of phosphonites and phosphinites of the general formulae:
R^{a}R^{b}PO₂⁻, R^{a}HPO₂⁻, R^{a}R^{b}PO⁻, R^{a}HPO⁻
the group of carboxylic acids of the general formula:
R^{a}COO⁻
the group of borates of the general formulae:
BO₃³⁻, HBO₃²⁻, H₂BO₃⁻, R^{a}R^{b}BO₃⁻, R^{a}HBO₃⁻, R^{a}BO₃²⁻,
B(OR^{a})(OR^{b})(OR^{c})(OR^{d})⁻, B(HSO₄)⁻, B(R^{a}SO₄)⁻
the group of boronates of the general formulae:
R^{a}BO₂²⁻, R^{a}R^{b}BO⁻
the group of silicates and silicic esters of the general formulae:
SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the general formulae:
R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻
the group of carboximides, bis(sulfonyl)imides and sulfonylimides of the general formulae: 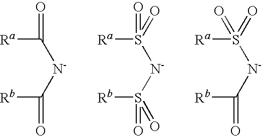
and the group of methides of the general formula: 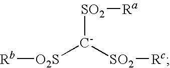
where the radicals R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-containing heterocycle, where two of them may also together form an unsaturated, saturated or aromatic ring which may optionally be interrupted by one or more oxygen and/or sulfur atoms and/or one or more unsubstituted or substituted imino groups, where the radicals mentioned may each be additionally substituted by suitable functional groups, aryl, alkyl, aryloxy, alkyloxy, halogen, heteroatoms and/or heterocycles.

8. The process according to claim 5, wherein [A]⁺ is a cation selected from the group of the compounds IIIa, IIIe, IIIf; IIIg, IIIg′, IIIh, IIIi, IIIj, IIIj′, IIIk, IIIk′, IIIl, IIIm, IIIm′, IIIn and IIIn′.

9. The process according to claim 5, wherein [A]⁺ is a cation selected from the group of the compounds IIIa, IIIe and IIIf.

10. The process according to claim 5, wherein [Y]ⁿ⁻ is an anion selected from the group of halides and halogen-containing compounds, the group of carboxylic acids, the group consisting of SO₄²⁻, SO₃²⁻, R^{a}OSO₃⁻ and R^{a}SO₃⁻ and the group consisting of PO₄³⁻ and R^{a}R^{b}PO₄⁻.

11. The process according to claim 5, wherein [Y]ⁿ⁻ is chloride.

12. The process according to claim 1, wherein the vinyl ether is a compound of the formula IV 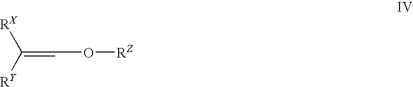
where the radicals have the following meanings:
R^{X}, R^{Y} are each hydrogen, C₁-C₃₀-alkyl, C₂-C₃₀-alkenyl, C₂-C₃₀-alkynyl, C₃-C₁₂-cycloalkyl, C₅-C₁₂-cycloalkenyl, aryl or heterocyclyl, where the last seven radicals may optionally be substituted; and
R^{Z} is C₁-C₃₀-alkyl, C₂-C₃₀-alkenyl, C₂-C₃₀-alkynyl, C₃-C₁₂-cycloalkyl, C₅-C₁₂-cycloalkenyl, aryl or heterocyclyl, where these seven radicals may optionally be substituted;
or
R^{X} and R^{Y} together form an optionally substituted —(CH₂)ₒ—Xₚ—(CH₂)_{q}— or —CH═CH—CH═CH— chain, where
X is O, S, S(═O), S(═O)₂ or N(C₁-C₄-alkyl);
o,q are each 1, 2, 3, 4, 5 or 6; and
p is 0 or 1;
or
R^{X} and R^{Z} together form an optionally substituted —(CH₂)ᵣ—Yₛ—(CH₂)ₜ— chain, where
Y is O, S, S(═O), S(═O)₂ or N(C₁-C₄-alkyl);
r, t are each 1, 2, 3, 4, 5 or 6; and
s is 0 or 1.

13. The process according to claim 12, wherein the radicals of the vinyl ether of the formula IV have the following meanings:
R^{X} is hydrogen or C₁-C₁₈-alkyl;
R^{Y} is hydrogen; and
R^{Z} is C₁-C₁₈-alkyl.

14. The process according to claim 12, wherein the radicals of the vinyl ether of the formula IV have the following meanings:
R^{X} is 1-decyl, 1-dodecyl, 1-tetradecyl or 1-hexadecyl;
R^{Y} is hydrogen; and
R^{Z} is C₁-C₁₈-alkyl.

15. The process according to claim 12, wherein the radicals of the vinyl ether of the formula IV have the following meanings:
R^{X} and R^{Z} together form a —(CH₂)ᵣ—(CH₂)ₜ— chain; and
R^{Y} is hydrogen.

16. The process according to claim 1, wherein the concentration of polysaccharide, oligosaccharide or disaccharide or a derivative thereof in the ionic liquid is in the range from 0.1 to 50% by weight, based on the total weight of the solution.

17. The process according to claim 1, wherein the reaction is carried out at a temperature from the melting point of the ionic liquid to 200° C.

18. The process according to claim 1, wherein the vinyl ether of the formula IV is used in stoichiometric amounts or in excess, based on the number of hydroxy groups of the polysaccharide, oligosaccharide or disaccharide or a derivative thereof.

19. An acetalated cellulose produced by the process according to claim 12, wherein
R^{X} and R^{Z} together form an optionally substituted —(CH₂)ᵣ—Yₛ—(CH₂)ₜ— chain, where
Y is O, S, S(═O), S(═O)₂ or N(C₁-C₄-alkyl);
r,t are each 1, 2, 3, 4, 5 or 6; and
s is 0 or 1;
and
R^{Z} is C₁-C₃₀-alkyl, C₂-C₃₀-alkenyl, C₂-C₃₀-alkynyl, C₃-C₁₂-cycloalkyl, C₅-C₁₂-cycloalkenyl, aryl or heterocyclyl, where these seven radicals may optionally be substituted.

20. A process for preparing crosslinked cellulose, wherein a polysaccharide or oligosaccharide or a corresponding derivative is dissolved in at least one ionic liquid and reacted with a vinyl ether according to claim 1 and the product obtained in this way is treated with an acid.

21. The process according to claim 20, wherein the reaction product of the polysaccharide or oligosaccharide or the corresponding derivative with a vinyl ether is isolated.

22. The process according to claim 20, wherein the reaction product of the polysaccharide or oligosaccharide or the corresponding derivative with a vinyl ether is subjected without isolation to the treatment with the acid.

23. The process according to claim 20, wherein HCl, H₂SO₄, H₃PO₄, acetic acid, chlorofluoroacetic acid, trifluoroacetic acid, perfluoropropionic acid, methanesulfonic acid or trifluoromethanesulfonic acid is used as the acid.

24. A crosslinked cellulose obtainable by the process according to claim 20.
